(19) United States
(12) Patent Application Publication
(10) Pub. No.: US 2022/0254170 A1
(43) Pub. Date: Aug. 11, 2022

(54) Sensor Information Processing Device

(71) Applicant: Hitachi Astemo, Ltd., Hitachinaka-shi, Ibaraki (JP)

(72) Inventors: Kento KAGIMOTO, Hitachinaka-shi (JP); Hitoshi HAYAKAWA, Hitachinaka-shi (JP); Yuya TANAKA, Hitachinaka-shi (JP)

(21) Appl. No.: 17/629,442

(22) PCT Filed: Jul. 21, 2020
(86) PCT No.: PCT/JP2020/028223

§ 371 Date: Jan. 24, 2022

(30) Foreign Application Priority Data
Aug. 6, 2019 (JP) 2019-144330

(51) Int. Cl. G06V 20/56; G06T 7/70; B60W 40/06; B60W 30/12

(52) U.S. Cl. CPC G06V 20/588; G06T 7/70; B60W 40/06; B60W 30/12; G06T 2207/10012; B60W 2556/50; B60W 2420/42; B60W 2552/53; B60W 2556/10; B60W 2556/25; B60W 2556/40; G06T 2207/30256

(57) ABSTRACT

Provided is a sensor information processing device that processes the detection results of the plurality of external-environment sensors that recognize the lane marker that divides the lane and can identify the lane marker more accurately than before. A sensor information processing device 100 includes a storage device 102 that stores a past detection result De of an external-environment sensor 200 as time-series data, and a central processing unit 101 that identifies a lane marker on the basis of the time-series data. The central processing unit 101 determines that the new detection result De belongs to the existing lane marker or the new lane marker on the basis of the comparison between the new detection result De not included in the time-series data and the time-series data.

### TECHNICAL FIELD

The present disclosure relates to a sensor information processing device.

### BACKGROUND ART

Conventionally, when driving automatically in a road environment where there are multiple lanes such as a highway, it is known that automatic traveling vehicles can automatically drive while determining and specifying the continuity of the driving division line (lane boundary line) (see PTL 1 below). This conventional automatic traveling vehicle is provided with a device that recognizes a traveling division line from a road image obtained by recognizing a traveling path in a vehicle traveling direction (see claim 1 and the like in the same document).

The recognition device includes the following means (a) to (f) (see claim 1 and the like in the same document). (a) A means for extracting at least one line segment from the road image. (b) A means for identifying the driving division line of a road from the line segments extracted at predetermined time intervals. (c) A means for estimating the traveling locus of a vehicle from the time of the previous identification to the time of the current identification. (d) A means for determining the continuity between the travel division line identified up to the previous time and the travel division line identified this time on the basis of the estimated travel locus and the travel division line identified this time. (e) A means for assigning the same identifier to the traveling division line identified on the basis of the determination result. (f) A means for storing the information of the traveling division line to which the identifier is assigned.

With such a configuration, in the above-mentioned conventional automatic traveling vehicle, the continuity of the lane boundary line is determined, the same identifier is assigned, and the specific information is stored, so that the lane boundary line can be specified extremely easily. The amount of calculation is also reduced (see paragraph 0007, and the like the same document).

### CITATION LIST

### Patent Literature

PTL 1: JP 2003-203298 A

### SUMMARY OF INVENTION

### Technical Problem

In the conventional automatic traveling vehicle described above, the rightmost lane boundary line is set as the reference lane boundary line, the distance from the own vehicle, which is the origin, to each lane boundary line is measured, the distance from the reference lane boundary line to each lane boundary line is obtained, and a lane boundary line number is assigned to each lane boundary line (see paragraphs 0017-0023, and the like in the same document). That is, this conventional automatic traveling vehicle determines the continuity of the lane boundary line based on the distance from the own vehicle to the nearest lane boundary line. Therefore, if the number of lanes increases or decreases due to, for example, a lane branching from a traveling lane or a lane joining the traveling lane, different lane boundaries may be mistakenly recognized as the same lane boundary.

The present disclosure provides a sensor information processing device that processes the detection results of the plurality of external-environment sensors that recognize the lane marker that divides the lane and can identify the lane marker more accurately than before.

### Solution to Problem

One aspect of the present disclosure is a sensor information processing device that identifies a lane marker by processing detection results of a plurality of external-environment sensors that recognize the lane marker that divides a lane, the sensor information processing device comprising: a storage device that stores past detection results as time-series data; and a central processing unit that identifies the lane marker on a basis of the time-series data, wherein on a basis of a comparison between the new detection result not included in the time-series data and the time-series data, the central processing unit determines that the new detection result belongs to the existing lane marker or the new lane marker.

### Advantageous Effects of Invention

According to the above aspect of the present disclosure, it is possible to provide a sensor information processing device that processes the detection results of the plurality of external-environment sensors that recognize the lane marker that divides the lane and can identify the lane marker more accurately than before.

### BRIEF DESCRIPTION OF DRAWINGS

FIG. 1 is a hardware configuration diagram illustrating an embodiment of a sensor information processing device according to the present disclosure.

FIG. 2 is a functional block diagram of the sensor information processing device illustrated in FIG. 1.

FIG. 3A is a plan view of a vehicle equipped with the sensor information processing device illustrated in FIG. 1 when traveling in a lane.

FIG. 3B is a conceptual diagram of a new detection result of an external-environment sensor of the vehicle illustrated in FIG. 3A.

FIG. 3C is a conceptual diagram of time-series data of the detection results of the external-environment sensor of the vehicle illustrated in FIG. 3A.

FIG. 4 is a functional block diagram of an identifier assignment function of the sensor information processing device illustrated in FIG. 2.

FIG. 5 is a flow diagram of processing by the identifier assignment function illustrated in FIG. 4.

FIG. 6 is a flow diagram of processing by a distance calculation function illustrated in FIG. 4.

FIG. 7 is an explanatory diagram of processing by the distance calculation function illustrated in FIG. 4.

FIG. 8 is a flow diagram of processing by an association function illustrated in FIG. 4.

FIG. 9 is a flow diagram of processing by an approximate curve generation function illustrated in FIG. 4.

FIG. 10 is a functional block diagram illustrating an embodiment of the sensor information processing device according to the present disclosure.

### DESCRIPTION OF EMBODIMENTS

Hereinafter, embodiments of a sensor processing device according to the present disclosure will be described with reference to the drawings.

### First Embodiment

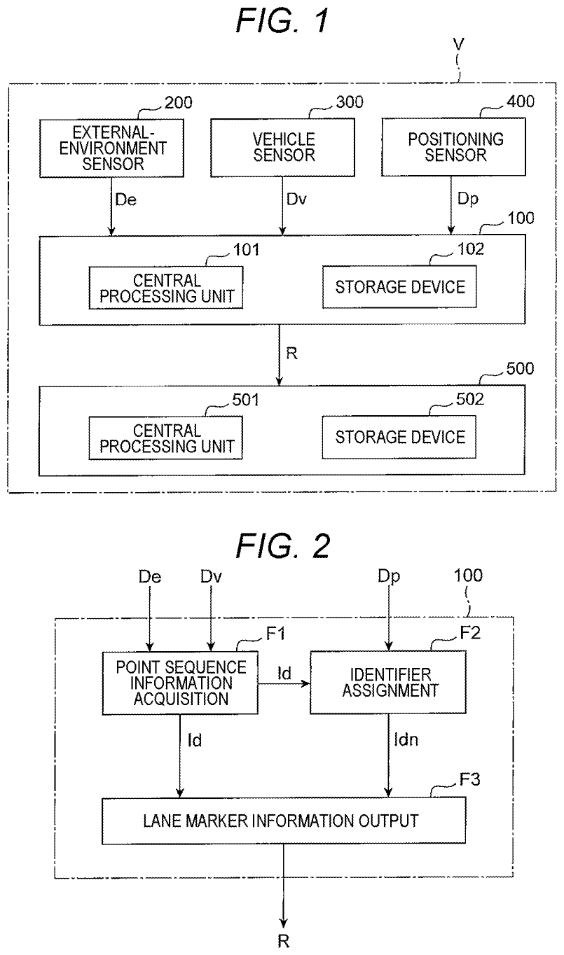

FIG. 1 is a hardware configuration diagram illustrating an embodiment of a sensor information processing device according to the present disclosure. A sensor information processing device 100 of the present embodiment is mounted on a vehicle V, for example, and constitutes a part of an advanced driver assistance system (ADAS) and an automated driving system (AD).

The sensor information processing device 100 includes, for example, a central processing unit (CPU) 101, a storage device 102 such as a memory or a hard disk, a computer program stored in the storage device 102, and an input/output device (not illustrated). The sensor information processing device 100 is, for example, a computer system such as firmware or a microcontroller. Further, the sensor information processing device 100 may be a part of an electronic control unit (ECU) for ADAS or AD mounted on the vehicle V, for example.

The sensor information processing device 100 is connected to, for example, an external-environment sensor 200, a vehicle sensor 300, a positioning sensor 400, and a lane marker information integration device 500 mounted on the vehicle V via a CAN (Controller Area Network), an in-vehicle Ethernet, or the like so as to communicate. The sensor information processing device 100 receives detection results De, Dv, and Dp from the external-environment sensor 200, the vehicle sensor 300, and the positioning sensor 400, respectively, and outputs a processing result R of these sensor information to the lane marker information integration device 500. Details of the functions of the sensor information processing device 100 will be described later.

The sensor information processing device 100 is configured to repeatedly operate at a predetermined cycle, for example. The operation cycle of the sensor information processing device 100 is not particularly limited, but may be a fixed cycle of, for example, about 100 [msec]. The operation cycle of the sensor information processing device 100 can be set to, for example, a cycle suitable for vehicle control. Specifically, for example, the operation cycle of the sensor information processing device 100 is not fixed, but can be appropriately changed according to the operation cycles of the external-environment sensor 200 and the vehicle sensor 300. For example, in consideration of the influence of periodic fluctuations and deviations, the information from the external-environment sensor 200 can be reliably acquired by the sensor information processing device 100.

The external-environment sensor 200 is a sensor mounted on the vehicle V and recognizing the environment around the vehicle V. The external-environment sensor 200 includes, for example, two or more, that is, a plurality of external-environment sensors among a stereo camera device, an omnidirectional bird's-eye view camera system, a LIDAR (Light Detection and Ranging), a monocular camera device, and other sensors capable of recognizing lane markers. Here, the lane marker or lane marking is a road marking that divides a lane on a road, and includes a lane boundary line displayed by a solid or broken white or yellow line. As the lane marker, for example, road marking paint, road studs, poles, stones and the like are generally used.

The recognition of the lane marker by the external-environment sensor 200 will be described by taking a stereo camera device as an example. The stereo camera device, which is the external-environment sensor 200, recognizes the lane marker from, for example, image information. Further, the stereo camera device generates a parallax image from, for example, images of two cameras, and calculates the distance and direction from the vehicle V for each pixel of the image of the lane marker.

The detection result De of at least one of the plurality of external-environment sensors 200 includes, for example, the time when the process of recognizing the lane marker is performed, a recognition point sequence of the lane marker, and point sequence meta information. The recognition point sequence of the lane marker is an array, that is, a point sequence in which the points on each lane marker recognized by the plurality of external-environment sensors 200 are represented by the vehicle coordinate system. The vehicle coordinate system is, for example, a coordinate system consisting of an X axis having the center of the axle of the rear wheel of the vehicle V as the origin and the front of the vehicle V as the positive direction, and a Y axis having the left direction of the vehicle V as the positive direction.

Further, the point sequence meta information is information including the type of each external-environment sensor included in the plurality of external-environment sensors 200 and the type of lane marker such as the line type of the lane marking. When the detection result De of the external-environment sensor 200 includes such point sequence meta information, in the lane marker information integration device 500, there is an advantage that it becomes possible to integrated processing of the information of a plurality of lane markers based on the type of the lane marker such as the line type of the lane marking.

In the present embodiment, it is assumed that the detection result De of the plurality of external-environment sensors 200 includes a recognition processing time, the recognition point sequence, and the point sequence meta information. In the processing described below, the recognition processing time, that is, the time when the processing for recognizing the lane marker is performed may be replaced by the time when the detection result De of the external-environment sensor 200 is input to the sensor information processing device 100. This makes it possible to save the transfer band at the input of the sensor information processing device 100.

The detection result De of at least one of the plurality of external-environment sensors 200 may be a parameter of an approximate curve based on the shape of the lane marker, such as a coefficient of a quadratic curve based on the shape of the lane marker. In this case, the information capacity of the detection result De can be reduced as compared with the case where the detection result De is a recognition point sequence. The parameters of the approximate curve can be converted into a point sequence by, for example, taking points every 0.5 [m] on an approximate straight line.

The vehicle sensor 300 includes, for example, a speed sensor, an acceleration sensor, an angular velocity sensor, a steering angle sensor, a brake sensor, an accelerator sensor, a gyro sensor, an engine rotation sensor, a shift sensor, and the like mounted on the vehicle V. The vehicle sensor 300 outputs the detection result Dv including, for example, speed, acceleration, angular velocity, steering angle, brake pedal force, accelerator opening, posture in the global coordinate system, engine rotation speed, shift position, and the like of the vehicle V to the sensor information processing device 100. The detection result Dv output by the vehicle sensor 300 does not necessarily include all the above-mentioned information, but includes, for example, at least the speed, acceleration, and angular velocity of the vehicle V.

The positioning sensor 400 is, for example, a satellite positioning system such as GPS (Global Navigation Satellite System) or GNSS (Global Navigation Satellite System) mounted on the vehicle V, and outputs the position and the orientation of the vehicle V to the sensor information processing device 100 as the detection result Dp. Further, the positioning sensor 400 may use, for example, a speed sensor, an angular velocity sensor, a gyro sensor, or the like included in the vehicle sensor 300, and may complement positioning by a satellite positioning system, for example, between tunnels and high-rise buildings.

The position and the orientation of the vehicle V may be accurately obtained by the positioning sensor 400 in a short cycle, and the differences between the positions and the orientations between the previous cycle and the current cycle may be calculated. In this case, when the position and the orientation of the vehicle V are obtained on the basis of the detection result of the wheel or steering by the vehicle sensor 300, the error due to the change in the speed or the rotation speed depending on the state of the wheel or the ground may be eliminated.

The lane marker information integration device 500 includes, for example, a CPU 501, a storage device 502, a computer program stored in the storage device 502, and an input/output device (not illustrated). The lane marker information integration device 500 is, for example, a computer system such as firmware or a microcontroller. Further, the lane marker information integration device 500 may be a part of an ECU for ADAS or AD mounted on the vehicle V, for example.

The lane marker information integration device 500 stores the processing result R output from the sensor information processing device 100, the detection result of another sensor that can recognize the lane marker, the identification result of the lane marker at another time, and the like to the storage device 502. Then, the processing result R, the detection result, the identification result, and the like stored in the storage device 502 are integrated by the CPU 501. As a result, the lane marker information integration device 500 improves the accuracy, range, smoothness, required amount of memory, and the like of the identification result of the lane marker.

As a specific improvement method, for example, the CPU 501 first obtains a point sequence obtained by taking a simple union of identification results having the same identifier among the identification results of the plurality of lane markers. Next, the CPU 501 takes the average of a plurality of points included in the point sequence that are close to each other, reduces the number of points of the point sequence by obtaining some representative points, and obtains the number of points that requires less necessary memory capacity while reducing the influence of the error caused by the law of large numbers. The processing by the lane marker information integration device 500 is not limited to the above method. For example, the CPU 501 may obtain an approximate curve from a point sequence obtained by the union and calculate the parameters of the approximate curve. Further, the CPU 501 may improve the smoothness by using points taken at regular intervals on the approximate curve as a new point sequence.

Hereinafter, the functions of the sensor information processing device 100 of the present embodiment will be described in detail with reference to FIGS. 2 to 9. FIG. 2 is a functional block diagram of the sensor information processing device 100 illustrated in FIG. 1.

The sensor information processing device 100 has, for example, a function F1 for acquiring point sequence information, a function F2 for assigning an identifier, and a function F3 for outputting lane marker information. Each of these functions is composed of, for example, the CPU 101 constituting the sensor information processing device 100, the storage device 102, the computer program stored in the storage device 102, and the input/output device (not illustrated).

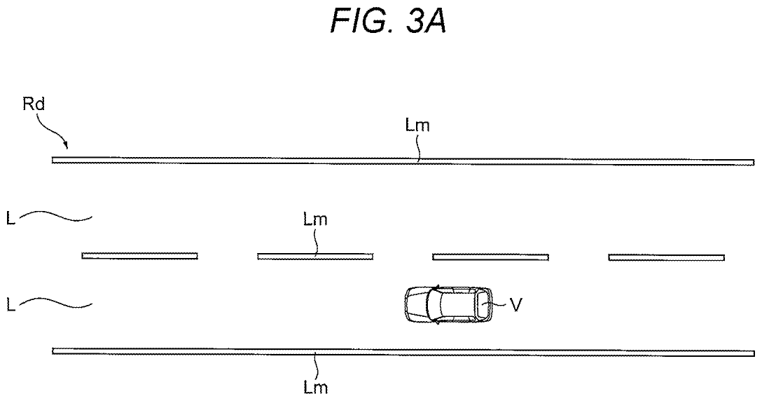

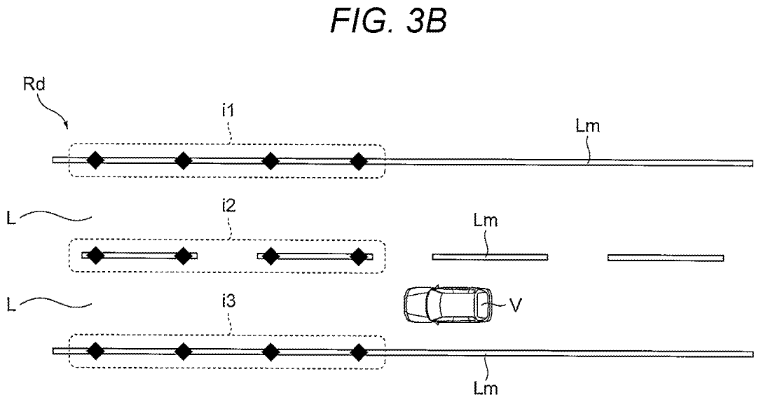

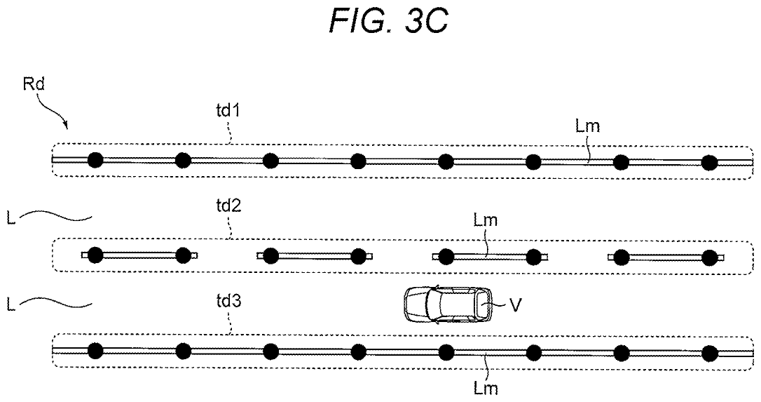

FIG. 3A is a plan view illustrating a state in which the vehicle V equipped with the sensor information processing device 100, the external-environment sensor 200, the vehicle sensor 300, the positioning sensor 400, and the lane marker information integration device 500 is running in a lane L separated by a lane marker Lm on a road Rd. FIG. 3B is a conceptual diagram of a new detection result De of the external-environment sensor 200 of the vehicle V illustrated in FIG. 3A. FIG. 3C is a conceptual diagram of time-series data td1, td2, and td3 of the detection result De of the external-environment sensor 200 of the vehicle V illustrated in FIG. 3A.

For example, as illustrated in FIG. 3A, an image pickup device such as a stereo camera or a monocular camera included in the external-environment sensor 200 mounted on the vehicle V takes images of other vehicles around the vehicle V, pedestrians, obstacles, the road Rd, lane marker Lm, and the like while the vehicle V is running in the lane L on the road Rd. As described above, the external-environment sensor 200 outputs the detection result De including the recognition processing time of the lane marker Lm, the recognition point sequence, and the point sequence meta information to the sensor information processing device 100, for example.

The sensor information processing device 100 sequentially processes the detection result De of each sensor included in the plurality of external-environment sensors 200. That is, the sensor information processing device 100 sequentially executes the processing of the detection result De of each external-environment sensor 200 at a predetermined cycle. The sensor information processing device 100 preferentially processes, for example, the detection result De of the external-environment sensor 200 having a large amount of information. As a result, the detection result De of the external-environment sensor 200 to be processed next can be compared with the detection result De of the previous external-environment sensor 200 that has a larger amount of information stored in the storage device 102, and the accuracy of the comparison is improved.

The sensor information processing device 100 may, for example, process the detection results De of the plurality of external-environment sensors 200 in parallel. As a result, the processing time of the detection results De of the plurality of external-environment sensors 200 can be reduced. Further, the sensor information processing device 100 may store the time-series data of the detection result De for each external-environment sensor 200 in the storage device 102 to reduce the influence of the difference between the detection results De of the individual external-environment sensors 200.

As illustrated in FIG. 3B, the new detection result De of the external-environment sensor 200 is stored in the storage device 102 of the sensor information processing device 100 as inputs i1, i2, and i3, for example. Further, as illustrated in FIG. 3C, the storage device 102 stores the identification result Id of the lane marker Lm based on the past detection result De of the external-environment sensor 200 as, for example, the time-series data td1, td2, and td3. In the examples illustrated in FIGS. 3B and 3C, the inputs i1, i2, and i3 and the time-series data td1, td2, and td3 each are configured by point sequences, that is, the recognition point sequences, which are the recognition results of the lane marker Lm by the external-environment sensor 200.

The function F1 for acquiring the point sequence information receives, as inputs for example, the detection result De of the external-environment sensor 200 and the detection result Dv of the vehicle sensor 300. In this function F1, the central processing unit 101 aligns the recognition result formats of the lane markers Lm included in the detection result De input from the external-environment sensor 200, and synchronizes the recognition processing times. After that, the central processing unit 101 outputs the identification result Id of the lane marker Lm for each sensor included in the plurality of external-environment sensors 200 to the function F2 for assigning an identifier and the function F3 for outputting the lane marker information.

When the recognition result of the lane marker Lm included in the detection result De of the external-environment sensor 200 is a parameter of the approximate curve, in the function F1 for acquiring the point sequence information, the central processing unit 101 generates a plurality of points at an appropriate interval on the approximate curve, and converts the points into a point sequence format. The distance between the points in the point sequence may be fixed or variable. When the interval between points is variable, for example, the upper limit of the number of points included in the recognition point sequence is fixed, the interval between points is narrowed when the speed of vehicle V is low, and the interval between points is widened when the speed of the vehicle V is high. This facilitates the estimation of the required amount of information.

Further, in the function F1 for acquiring the point sequence information, the central processing unit 101 unifies the coordinates of each point constituting the point sequence and the coordinates of the local coordinate system when converting the parameters of the approximate curve, which is the recognition result of the lane marker Lm, into the format of the point sequence. The local coordinate system is a coordinate system consisting of an X axis having the center of the axle of the rear wheel of the vehicle V as the origin and a positive direction in front of the vehicle V and a Y axis having a positive direction to the left of the vehicle V.

Further, when the recognition result of the lane marker Lm included in the detection result De of the external-environment sensor 200 is a point sequence, the central processing unit 101 acquires the recognition result as it is in the function F1 for acquiring the point sequence information. If the acquired coordinates of the point sequence are not the coordinates of the local coordinate system, the central processing unit 101 converts the coordinates of the point sequence into the coordinates of the local coordinate system. Further, in the function F1 for acquiring the point sequence information, the central processing unit 101 adjusts the recognition processing time of each external-environment sensor 200 to the start time of the processing cycle by the sensor information processing device 100.

Specifically, in the function F1 for acquiring the point sequence information, the central processing unit 101 calculates the difference time between the start time of the processing cycle and the recognition processing time of each external-environment sensor 200. Further, the central processing unit 101 estimates the movement amount of the vehicle V in the difference time based on the speed and the angular velocity of the vehicle V included in the detection result Dv of the vehicle sensor 300 by a constant velocity circular motion model, and adjusts the positions of the recognition point sequence. Further, the central processing unit 101 changes the recognition processing time included in the detection result De of the external-environment sensor 200 to the start time of the processing cycle after synchronization.

As described above, in the function F2 for assigning an identifier of the sensor information processing device 100, the detection result De of the lane marker Lm having the same processing cycle can be utilized without being aware of the time. The motion model for estimating the movement amount of the vehicle V in the difference time is not limited to the constant velocity circular motion model, and may be a constant velocity linear motion model or a model that takes acceleration into consideration, and can be changed according to the processing cycle of the sensor information processing device 100.

The function F2 for assigning an identifier receives, as inputs for example, the detection result Dp including the position and orientation of the vehicle V, which is the output of the positioning sensor 400, and the identification result Id of the lane marker Lm for each sensor included in the plurality of external-environment sensors 200 which is the output of the function F1 for acquiring the point sequence information. Further, the function F2 for assigning an identifier outputs an identifier Idn corresponding to the identification result Id of the lane marker Lm on the basis of these inputs.

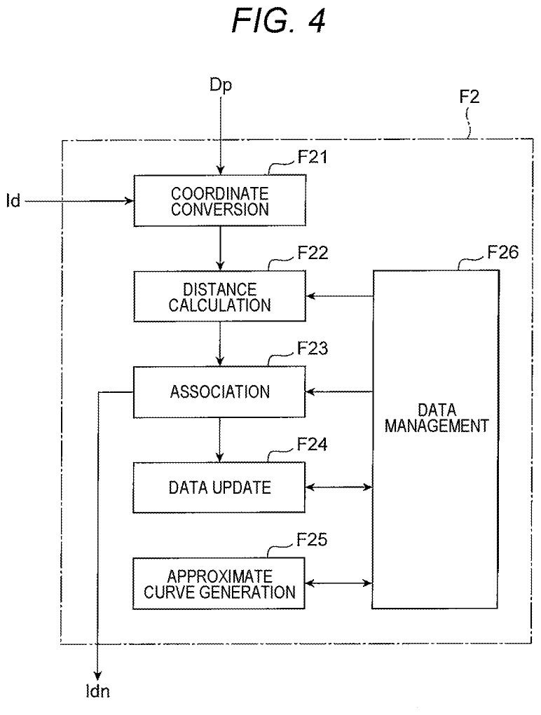

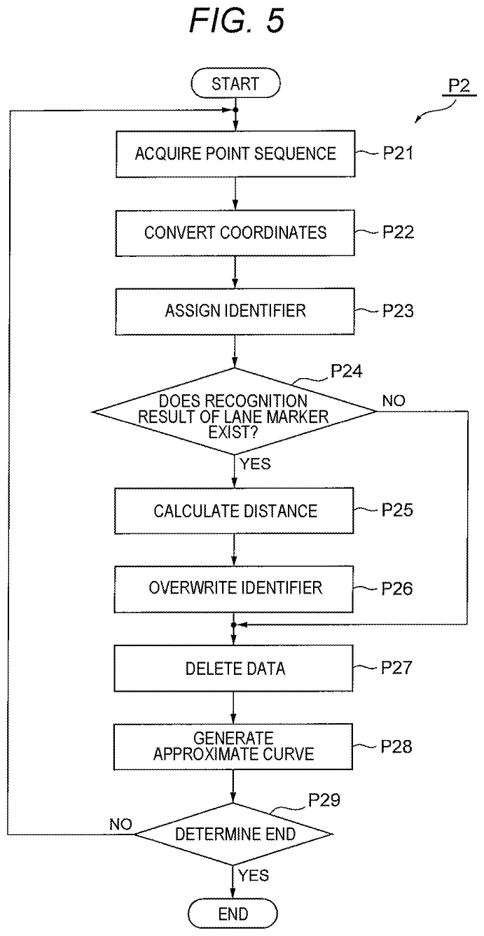

FIG. 4 is a functional block diagram of the function F2 for assigning an identifier to the sensor information processing device 100 illustrated in FIG. 2. FIG. 5 is a flow diagram of processing P2 by the function F2 for assigning an identifier illustrated in FIG. 4. The function F2 for assigning an identifier to the sensor information processing device 100 is, for example, a coordinate conversion function F21, a distance calculation function F22, an association function F23, a data update function F24, a function F25 for generating an approximate curve, and a data management function F26.

The coordinate conversion function F21 receives, as inputs, the identification result Id of the lane marker Lm for each sensor of the external-environment sensor 200, which is the output of the function F1 for acquiring the point sequence information, and the detection result Dp of the positioning sensor 400. In the present embodiment, the identification result Id input from the function F1 for acquiring the point sequence information to the function F2 for assigning an identifier is the point sequence information. That is, in the coordinate conversion function F21, the central processing unit 101 executes processing P21 for acquiring the identification result Id as the point sequence information from the function F1 for acquiring the point sequence information.

Further, in the coordinate conversion function F21, the central processing unit 101 executes processing P22 for converting the coordinates of the local coordinate system included in the input information into the coordinates of the global coordinate system which is a fixed coordinate system. Further, in the coordinate conversion function F21, the central processing unit 101 executes processing P23 for assigning a new identifier to the inputs i1, i2, and i3, which are the new detection results De of the external-environment sensor 200. Further, in the coordinate conversion function F21, the central processing unit 101 executes processing P24 for determining the existence of the time-series data td1, td2, and td3 of the identification result Id of the lane marker Lm.

In the processing P24, for example, when the time-series data td1, td2, and td3 of the lane marker Lm are not stored in the storage device 102, the central processing unit 101 determines that the identification result Id of the lane marker Lm does not exist (NO). Then, the central processing unit 101 outputs the inputs i1, i2, and i3, which are the new detection results De of the external-environment sensor 200 to which a new identifier is given, to the data update function F24 via the distance calculation function F22 and the association function F23. After that, the data update function F24 executes processing P27 for deleting data described later.

On the other hand, in the processing P24, for example, when the time-series data td1, td2, and td3 of the lane marker Lm are stored in the storage device 102, the central processing unit 101 determines that the identification result Id of the lane marker Lm (YES) exists. In this case, the approximate curve of the time-series data td1, td2, and td3 of the lane markers Lm generated in the previous processing P28 by the function F25 for generating an approximate curve is stored in the storage device 102 by the data management function F26. Therefore, in the distance calculation function F22, the central processing unit 101 executes processing P25 for calculating an average distance between the inputs i1, i2, and i3 which are the new identification result Id of the lane marker Lm and the time-series data td1, td2, and td3 of the lane marker Lm in the distance calculation function F22.

In the processing P25 for calculating a distance in the distance calculation function F22, the central processing unit 101 receives, as inputs, the outputs of the coordinate conversion function F21, that is, the new inputs i1, i2, and i3 from the external-environment sensor 200 to which the new identifier is assigned. Further, in this processing P25, the central processing unit 101 receives, as inputs, the outputs of the data management function F26, that is, the time-series data td1, td2, and td3 of the lane marker Lm which are stored in the storage device 102. Then, in this processing P25, the central processing unit 101 calculates the average distance between the new inputs i1, i2, and i3 of the lane marker Lm and the time-series data td1, td2, and td3.

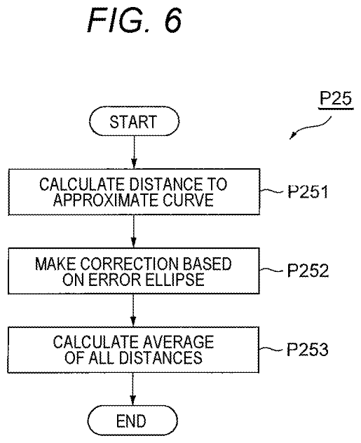

FIG. 6 is a flow diagram of the processing P25 by the distance calculation function F22 illustrated in FIG. 4. The processing P25 for calculating a distance by the distance calculation function F22 includes, for example, processing P251 for calculating a distance to the approximate curve, processing P252 for performing correction based on an error ellipse, and processing P253 for calculating the average of all distances.

In the processing P251, the central processing unit 101 obtains a distance between each point constituting the point sequence of each of the new inputs i1, i2, and i3 of the lane marker Lm and the approximate curve generated from the point sequence constituting each of the time-series data td1, td2, and td3. For example, as illustrated in FIGS. 3B and 3C, it is assumed that there are a point sequence of the plurality of inputs i1, i2, and i3 and an approximate curve of the plurality of pieces of time-series data td1, td2, and td3. In this case, the central processing unit 101 calculates the distance for all combinations of the point sequences of the inputs i1, i2, and i3 and the approximate curves of the time-series data td1, td2, and td3, for example.

In the present embodiment, in the processing P28 for generating an approximate curve by the function F25 for generating an approximate curve, which will be described later, an approximate curve including an approximate straight line and an approximate circle is generated by the central processing unit 101 on the basis of the time-series data td1, td2, and td3. The reason is that the shape of a general road Rd is basically composed of straight lines and arcs.

Therefore, in the present embodiment, in the processing P251 for calculating a distance to the approximate curve, the central processing unit 101 calculates an average distance between the point sequence of the inputs i1, i2, and i3 and each of the approximate straight line and the approximate circle of the time-series data td1, td2, and td3. That is, in the processing P251, two types of average distances are calculated: the average distance of the time-series data td1, td2, and td3 with respect to the approximate straight line of the time-series data td1, td2, and td3, and the average distance with respect to the approximate circle.

Further, in the processing P251 for calculating a distance from the approximate curve, the central processing unit 101 selects the smaller average distance of the above two average distances as the average distance to the approximate curve of the time-series data td1, td2, and td3. The reason is to deal with the situation in which the approximate circle of the time-series data td1, td2, and td3 tends to include an error with respect to the actual shape of the road Rd, and the type of the approximate curve changes, such as when the shape of the road Rd changes from a curve to a straight line.

Next to the processing P251 for calculating a distance from the approximate curve, the processing P252 for performing correction based on the error ellipse is executed. In this processing P252, the central processing unit 101 uses the error ellipse generated from the point sequence of the time-series data td1, td2, and td3 for each combination of the inputs i1, i2, and i3 and the time-series data td1, td2, and td3, and correct the average distance obtained in the previous processing P251. Specifically, the average distance is corrected by using the length of the long axis of the error ellipse generated from the point sequence of the time-series data td1, td2, and td3.

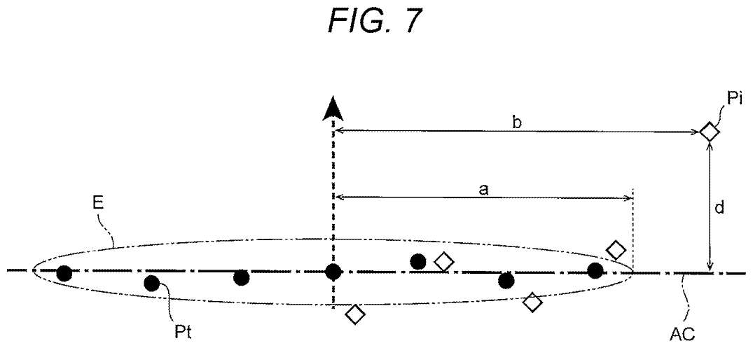

FIG. 7 is an explanatory diagram of the correction processing P252 based on an error ellipse E by the distance calculation function F22 illustrated in FIG. 4. In the correction processing P252 based on the error ellipse E, the central processing unit 101 calculates the corrected distance D by, for example, the following procedure. The central processing unit 101 first calculates a distance d from an approximate curve AC based on each point Pt of the time-series data td1, td2, and td3 of the lane marker Lm to a point Pi constituting the new inputs i1, i2, and i3, a distance b from the center of the error ellipse E in the major axis direction to the point Pi, and a major radius a of the error ellipse E. Next, the central processing unit 101 calculates the corrected distance D by Expression: D=d×b/a.

Such correction processing P252 is performed to select an approximate straight line or an approximate circle of the time-series data td1, td2, and td3 in which the average distance from each point Pi of the new inputs i1, i2, and i3 of the identification result Id of the lane marker Lm is smaller. In addition, the correction processing P252 is performed to prevent that the point Pi is associated with the time-series data passing nearby even though it is actually far from the distribution of the point sequence of the time-series data when only the distance d is used.

Note that FIG. 7 shows the concept of distance calculation in the linear approximation of the time-series data td1, td2, and td3. When performing a circular approximation of the time-series data td1, td2, and td3, the distance in a case where the coordinates of the inputs i1, i2, and i3 and the point sequence of the time-series data td1, td2, and td3 are expressed in polar coordinates is used instead of the Cartesian coordinate system used in the linear approximation.

Next, in the processing P253 for calculating the average of all distances, the central processing unit 101 calculates the average value of the distance D after each correction for each combination of the inputs i1, i2, and i3 and the time-series data td1, td2, and td3. As a result, the processing P25 for calculating the distance illustrated in FIGS. 5 and 6 by the distance calculation function F22 illustrated in FIG. 4 ends.

Next, the association function F23 illustrated in FIG. 4 executes processing P26 for overwriting the identifier illustrated in FIG. 5. In this processing P26, the association function F23 receives, as inputs, the average value of the corrected distance D, which is the output of the distance calculation function F22, and the approximate curve of the time-series data td1, td2, and td3 of the lane marker Lm stored in the storage device 102, which is the output of the data management function F26. In this processing P26, the central processing unit 101 determines the relevance between the inputs i1, i2, and i3 of the lane marker Lm and the time-series data td1, td2, and td3 on the basis of these inputs.

Further, in this processing P26, the central processing unit 101 outputs the point sequence of the inputs i1, i2, and i3 to which the identifier is assigned on the basis of the determination result of the relevance to the data update function F24. Then, in the data update function F24, the central processing unit 101 overwrites the identifier of the point sequence of the inputs i1, i2, and i3 stored in the storage device 102 as a new identifier or an identifier of the related time-series data td1, td2, and td3.

Here, the determination of the relevance between the inputs i1, i2, and i3 of the lane marker Lm and the time-series data td1, td2, and td3 will be described in more detail with reference to FIGS. 1 and 3A to 3C. Here, as an example, it is assumed that three lane markers Lm are recognized by the external-environment sensor 200 mounted on the vehicle V. In this case, the point sequence of the new inputs i1, i2, and i3 corresponding to the detection result De of each lane marker Lm is input from the external-environment sensor 200 to the sensor information processing device 100. Further, the storage device 102 constituting the sensor information processing device 100 stores the time-series data td1, td2, and td3 corresponding to the detection result De of the past lane marker Lm.

Here, it is assumed that the inputs i1, i2, and i3 and the time-series data td1, td2, and td3 are associated with each other in a one-to-one pair. In this case, if one of the inputs i1, i2, and i3 is associated with one of the time-series data td1, td2, and td3, then a candidate for a pair of one input and one time-series data, that is, a set of one input and one time-series data is created. Then, the candidates of other pairs or sets including the input or time-series data constituting the pair or set can be deleted, and the rest become the candidates to be adopted next.

Here, as an example, a pair of time-series data td1 and input i1, a pair of time-series data td2 and input i3, and a pair of time-series data td3 and input i2 are called “candidates”, and the candidates are collectively called a “combination”. For example, it is supposed that the candidate for the time-series data td1 and the input i1 is adopted. In this case, other candidates including the time-series data td1 or the input i1, for example, the time-series data td1 and the input i2, the time-series data td1 and the input i3, the time-series data td2 and the input i1, and the time-series data td3 and the input i1 each can be deleted. Then, the next candidate is adopted from the rest candidates, that is, the time-series data td2 and the input i2, the time-series data td2 and the input i3, the time-series data td3 and the input i2, and the time-series data td3 and the input i3.

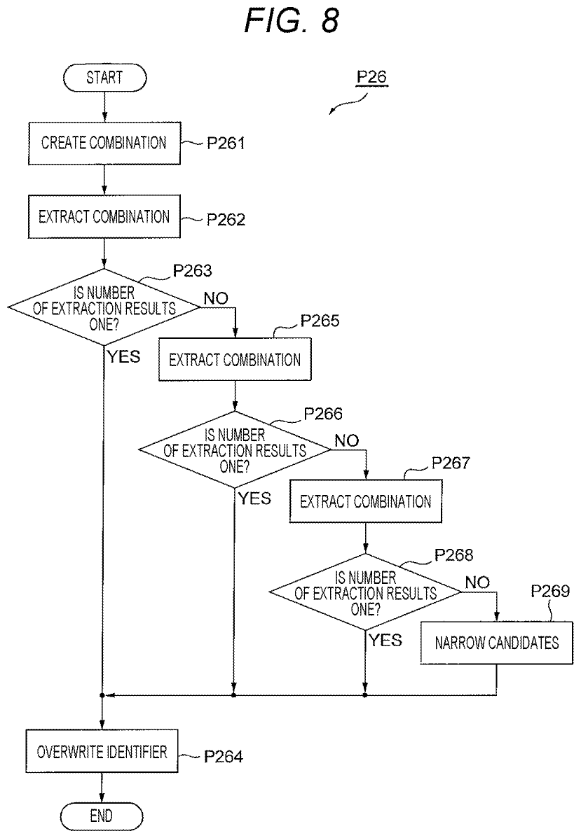

Further, with reference to FIG. 8, an example of the processing P26 for overwriting the identifier by the association function F23 illustrated in FIG. 4 will be described in detail. FIG. 8 is a flow diagram illustrating an example of the processing P26 for overwriting the identifier by the association function F23. The processing P26 for overwriting this identifier includes, for example, combination creation processing P261, combination extraction processing P262, P265, and P267, extraction result determination processing P263, P266, and P268, identifier overwriting processing P264, and candidate narrowing processing P269.

First, in the combination creation processing P261, the central processing unit 101 creates the candidates of pairs of all the time-series data td1, td2, and td3 and all the inputs i1, i2, and i3 and a list of the combinations. Next, the central processing unit 101 executes, for example, the combination extraction processing P262, P265, and P267, the extraction result determination processing P263, P266, and P268, and the candidate narrowing processing P269 on the basis of the created list, and a more suitable combination is extracted from among the combinations of all candidates.

Specifically, in the first combination extraction processing P262, the central processing unit 101 extracts a combination in which the distance D between the point sequence of the inputs i1, i2, and i3 of the lane marker Lm and the approximate curve of the time-series data td1, td2, and td3 of the lane marker Lm is equal to or less than a threshold value. As the threshold value of the distance D, for example, the width of the lane L can be used. Further, the central processing unit 101 extracts a combination that maximizes the number of candidates that are a pair of the time-series data and the input from among the extracted combinations.

Thereby, for example, it is possible to prevent any one of the time-series data td1, td2, and td3 and any one of the inputs i1, i2, and i3 from being left without association. Also, by using the width of the lane L as the threshold value, when each of the inputs i1, i2, and i3 and each of the time-series data td1, td2, and td3 are separated from the width of one lane L, it can be determined that the lane marker Lm is different.

After the end of the first combination extraction processing P262, the central processing unit 101 executes the first extraction result determination processing P263. In the first extraction result determination processing P263, the central processing unit 101 determines whether the number of combinations extracted by the first combination extraction processing P262 that maximize the number of candidates to be adopted is one. In this determination processing P263, when the central processing unit 101 determines that the number of combinations is one (YES), the identifier overwriting processing P264 is executed.

In the identifier overwriting processing P264, the central processing unit 101 overwrites the identifiers of the inputs i1, i2, and i3, among the combinations in which the inputs i1, i2, and i3 and the time-series data td1, td2, and td3 are associated, with the identifiers of the time-series data td1, td2, and td3. Further, in the identifier overwriting processing P264, the central processing unit 101 overwrites the identifiers of the inputs i1, i2, and i3 among the combinations in which the inputs i1, i2, and i3 and the time-series data td1, td2, and td3 are associated, with the new identifiers. As a result, the processing P26 for overwriting the identifier ends.

On the other hand, in the above-mentioned determination processing P263, when the central processing unit 101 determines that there are a plurality of combinations (NO), the central processing unit 101 executes the second combination extraction processing P265. In this second combination extraction processing P265, the central processing unit 101 extracts a combination that minimizes the sum of the distances D between the point sequence of the inputs i1, i2, and i3 of the lane marker Lm and the approximate curve of the time-series data td1, td2, and td3 of the lane marker Lm from the plurality of combinations. This is because in the combinations extracted by the first combination extraction processing P262, the number of candidates that are pairs of time-series data and input is the same, so it can be determined that the combinations with a smaller sum of the distances D are closer in distance for the candidates of input and time-series data, and the relevance is high.

After the end of the second combination extraction processing P265, the central processing unit 101 executes the second extraction result determination processing P266. In the second extraction result determination processing P266, the central processing unit 101 determines whether the number of combinations extracted by the second combination extraction processing P265 is one. In this determination processing P266, when the central processing unit 101 determines that the number of combinations is one (YES), the above-mentioned identifier overwriting processing P264 is executed, and the processing P26 for overwriting the identifier ends.

On the other hand, in the second extraction result determination processing P266, when the central processing unit 101 determines that there are a plurality of combinations (NO), the central processing unit 101 executes the third combination extraction processing P267. In the third combination extraction processing P267, the central processing unit 101 extracts a combination that minimizes the minimum value of the distances D between the point sequence of the inputs i1, i2, and i3 of the lane marker Lm and the approximate curve of the time-series data td1, td2, and td3 of the lane marker Lm from the plurality of combinations.

After the end of the third combination extraction processing P267, the central processing unit 101 executes the third extraction result determination processing P268. In the third extraction result determination processing P268, the central processing unit 101 determines whether the number of combinations extracted by the third combination extraction processing P267 is one. In this determination processing P268, when the central processing unit 101 determines that the number of combinations is one (YES), the above-mentioned identifier overwriting processing P264 is executed, and the processing P26 for overwriting the identifier ends.

On the other hand, in the third extraction result determination processing P268, when the central processing unit 101 determines that there are a plurality of combinations (NO), the central processing unit 101 executes the candidate narrowing processing P269. In the candidate narrowing processing P269, the central processing unit 101 extracts, for example, a combination having a small identifier number from the plurality of combinations. In many cases, one combination is narrowed down to the second extraction result determination processing P266. Therefore, the combination may be narrowed down based on other criteria such as arbitrarily extracting one combination or extracting a combination of the latest update time in the candidate narrowing processing P269. After the candidate narrowing processing P269 ends, the central processing unit 101 executes the above-mentioned identifier overwriting processing P264 and ends the processing P26 for overwriting the identifier.

As described above, in the present embodiment, in the association function F23, the similarity between the new inputs i1, i2, and i3 of the lane marker Lm and the time-series data td1, td2, and td3 is determined by their average distances. Therefore, the function F2 for assigning an identifier calculates the average distance between the new inputs i1, i2, and i3 of the lane marker Lm and the time-series data td1, td2, and td3 by the distance calculation function F22.

However, in the association function F23, it is also possible to determine the similarity between the new inputs i1, i2, and i3 of the lane marker Lm and the time-series data td1, td2, and td3 by the angle formed by these approximate curves. In this case, the function F2 for assigning an identifier may include, as a function after the coordinate conversion function F21, a function for calculating an angle formed by the approximate curve of the new inputs i1, i2, and i3 of the lane marker Lm and the approximate curve of the time-series data td1, td2, and td3 instead of the distance calculation function F22. This makes it possible to reduce the amount of calculation in the central processing unit 101.

After the processing P26 for overwriting the identifier ends, the data update function F24 illustrated in FIG. 4 executes the processing P27 for deleting the data illustrated in FIG. 5. In this processing P27, the data update function F24 receives, as inputs, the point sequence of the inputs i1, i2, and i3 of the lane marker Lm to which the identifier which is the output of the association function F23 is assigned and the time-series data td1, td2, and td3 of the lane marker Lm to which the identifier which is the output of the data management function F26 is assigned. On the basis of these inputs, the data update function F24 updates the time-series data td1, td2, and td3 of the lane marker Lm by the central processing unit 101 and outputs them to the data management function F26.

Specifically, in this processing P27, the central processing unit 101 adds the point sequence of the inputs i1, i2, and i3 of the lane marker Lm associated with the time-series data td1, td2, and td3 of the lane marker Lm to the time-series data td1, td2, and td3 together with a time stamp. Further, in this processing P27, the central processing unit 101 deletes a point which is farther backward from the vehicle V than a predetermined distance threshold value from among the point sequence of the time-series data td1, td2, and td3 having the same identifier, and deletes a point where the time before a predetermined time threshold value is recorded.

This prevents the number of points contained in the time-series data td1, td2, and td3 from increasing endlessly, and makes effective use of computer resources such as CPU and memory. The above-mentioned distance threshold value and time threshold value may be fixed values or variable values, and points included in the time-series data td1, td2, and td3 may be deleted on the basis of other indicators such as memory capacity. After the processing P27 for deleting this data ends, the processing P28 for generating an approximate curve is executed as illustrated in FIG. 5.

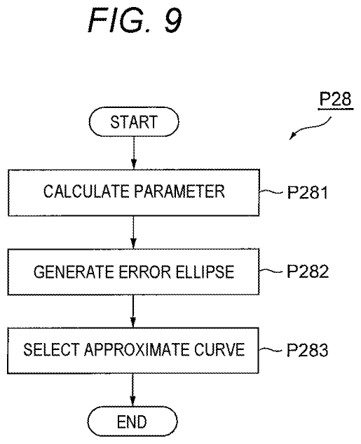

In the processing P28 for generating an approximate curve, the function F25 for generating an approximate curve receives, as inputs, the time-series data td1, td2, and td3 of the lane marker Lm which is the output of the data management function F26. In this processing P28, the function F25 for generating an approximate curve calculates the parameters of the approximate curve and the error ellipse by the central processing unit 101 on the basis of the time-series data td1, td2, and td3 of the input lane marker Lm, and outputs the parameters to the data management function F26. Hereinafter, the processing P28 for generating this approximate curve will be described in detail with reference to FIG. 9.

FIG. 9 is a flow diagram of the processing P28 for generating an approximate curve by the function F25 for generating an approximate curve illustrated in FIG. 4. This processing P28 includes, for example, processing P281 for calculating parameters, processing P282 for generating an error ellipse, and processing P283 for selecting an approximate curve. First, in the processing P281 for calculating parameters, the function F25 for generating an approximate curve calculates parameters of two types of approximate curves, a straight line and a circle, with respect to the point sequence of the time-series data td1, td2, and td3 by the central processing unit 101. That is, in the present embodiment, the approximate curve may have only a straight line, only an arc, or may include a straight line and an arc.

The parameters of the approximate straight line of the time-series data td1, td2, and td3 are calculated by the least squares method using, for example, the respective point sequences of the time-series data td1, td2, and td3. For example, let n be the number of points Pi included in each point sequence of the time-series data td1, td2, and td3, and let the coordinates of the points Pi be (xᵢ, yᵢ). Then, the parameters a, b, and c of the following Expression (1) and the parameters a′, b′, and c′ of the following Expression (2) are obtained.

### [Math. 1]

ax+by+=0 (1)

a=nΣxᵢyᵢ−ΣxᵢΣyᵢ

b=(Σxᵢ)²−nExᵢ²

c=Σxᵢ²Σyᵢ−ΣxᵢyᵢΣxₜ

### [Math. 2]

a′x+b′y+c′=0 (2)

a′=(Σyᵢ)²−nΣyᵢ²

b′=a

c′=ΣxᵢΣyᵢ²−ΣxᵢyᵢΣyᵢ

Here, when the inequality: b>a′ is satisfied, the parameters a′, b′, and c′ of the above Expression (2) are adopted as the parameters of the approximate straight line. In other cases, the parameters a, b, and c of the above Expression (1) are adopted as the parameters of the approximate straight line. In the above Expression (1), x and y are objects, and the above Expression (2) is a form in which x and y of the above Expression (1) are exchanged. However, the parameters of Expressions (1) and (2) above do not match, and one Expression can be approximated with higher accuracy than the other, depending on the distribution of the x and y coordinates of the points.

On the other hand, for the parameters of the approximate circle of the time-series data td1, td2, and td3, for example, three points are obtained as representative points from each point sequence of the time-series data td1, td2, and td3, and then a circle passing through the representative points is obtained. As a method of selecting the representative points of the approximate circle, each point sequence of the time-series data td1, td2, and td3 is sorted by the distance from the vehicle V and classified into three clusters. Then, by finding the center of gravity of each cluster, three representative points are calculated.

The center point and radius of the circle can be calculated on the basis of the representative points of these three points. Therefore, the representative points of these three points are used as the parameters of the approximate circle. In the sensor information processing device 100 of the present embodiment, the data update function F24 adds the point sequence of the inputs i1, i2, and i3 to the time-series data td1, td2, and td3 together with a time stamp. Therefore, as a method of selecting the representative point of the point sequence of the time-series data td1, td2, and td3, for example, it is also possible to select the time information such as the oldest time, the intermediate time, and the latest time. The representative point may be selected based on a criterion other than the time information.

Next, in the processing P282 for generating an error ellipse, the function F25 for generating an approximate curve uses the central processing unit 101 to obtain parameters of the error ellipse, for example, center, major axis, and minor axis, from the point sequence of the time-series data td1, td2, and td3 for each of the approximate straight line and the approximate circle. The error ellipse is obtained by a general formula obtained by assuming the χ² distribution from the covariance of the distribution.

In the sensor information processing device 100 of the present embodiment, the function F25 for generating an approximate curve obtains a distribution as follows, for example. Let the center of the error ellipse be the point closest to the center of gravity of each point sequence of the time-series data td1, td2, and td3. The major axis of the error ellipse is the direction of the approximate curve, that is, the tangential direction of the approximate straight line or the approximate circle, and the minor axis of the error ellipse is the direction perpendicular to the major axis.

Then, in the case of an approximate straight line, the major axis is calculated from the distribution in the direction represented by the approximate straight line, and the minor axis is calculated from the distribution in the direction perpendicular to the direction represented by the approximate straight line. In the case of an approximate circle, the major axis of the error ellipse is obtained from the value obtained by multiplying the angle and the distance using polar coordinates, that is, the distribution obtained in the circumferential direction of the approximate circle, and the minor axis is obtained from the distribution in the radial direction, that is, the center direction of the approximate circle on the circumference. In these definitions, the minor axis can be calculated from the distance between the approximate curve and each point of the time-series data td1, td2, and td3, and the major axis can be calculated by the distance from the center of the error ellipse on the approximate curve to each point of the time-series data td1, td2, and td3.

That is, the parameter of the error ellipse expresses the distribution of points included in the time-series data td1, td2, and td3 with reference to the approximate curve. In the case of linear approximation, the covariance matrix is obtained with the fixed coordinate values of the original local coordinate system, and the major axis and minor axis of the error ellipse are obtained by assuming the χ² distribution with two degrees of freedom for the eigenvalues. In the case of circular approximation, for each point of the time-series data td1, td2, and td3, the coordinates are converted from the orthogonal coordinates to the polar coordinates with the center of the approximate circle as the origin and the center of gravity as θ=0 (counterclockwise is positive), and the major axis and the minor axis of the error ellipse are obtained from the covariance matrix in the coordinate system in which the point at (rₚ, θₚ) is converted to (rₚθₚ, r−rₚ), similarly to the linear approximation.

Next, in the processing P283 for selecting an approximate curve, the function F25 for generating an approximate curve selects any one of the approximate curves of the approximate straight line and the approximate circle for the point sequence of the time-series data td1, td2, and td3 by the central processing unit 101. Here, for each point sequence of the time-series data td1, td2, and td3, the distance from the approximate curve is calculated to obtain the standard deviation. Then, an approximate curve with a smaller standard deviation is selected as a more suitable approximate curve. This is because the larger the value of the standard deviation, the different the approximate curve and the point sequence.

Here, when the value of the standard deviation is larger than the width of the standard road Rd, the central processing unit 101 considers that it is not represented by the approximate curve and deletes the time-series data td1, td2, and td3 itself. The output of the function F25 for generating an approximate curve contains, for example, the following parameters (a) to (f). (a) Coordinates of center point of gravity of the point sequence of time-series data td1, td2, and td3. (b) Three coefficients of the parameters of the approximate straight line, namely the coefficients a, b, and c or the coefficients a′, b′, and c′. (c) Parameters of the error ellipse in the case of linear approximation, that is, the major axis and the minor axis of the error ellipse. (d) Parameters of the approximate circle, that is, the coordinates and radius of the center point of the circle. (e) Parameters of the error ellipse in the case of circular approximation, that is, the major axis and the minor axis of the error ellipse. (f) Determination flag of the approximate curve, that is, a linear approximation flag or a circle approximation flag.

As described above, the function F25 for generating an approximate curve generates an approximate curve including a straight line or an arc for the time-series data td1, td2, and td3 having the same identifier by the central processing unit 101. In other words, the central processing unit 101 calculates an approximate curve parameter expressing the point sequence distribution from the point sequence information of each of time-series data td1, td2, and td3, and outputs the approximate curve parameter to the data management function F26.

As a result, when comparing the time-series data td1, td2, and td3 with the inputs i1, i2, and i3 by the distance calculation function F22, the processing time of the time-series data td1, td2, and td3 can be suppressed using the parameters of the approximate curve. The parameters of the approximate curve may include, for example, statistical information such as an error ellipse representing the point sequence distribution of the time-series data td1, td2, and td3, in addition to the parameters of the approximate curve itself.

Further, the function F25 for generating an approximate curve of the sensor information processing device 100 of the present embodiment adopts two types of linear approximation and circular approximation as the approximate curves for the time-series data td1, td2, and td3. This is because the shape of a general road Rd is composed of line segments, arcs, and cycloid curves as basic shapes. The straight line and the circle are expressed by an implicit function that is symmetrical with respect to the X and Y axes of the fixed coordinate system outside the vehicle V, and the fixed coordinate system also realizes an expression that does not depend on the direction of the vehicle V.

The data management function F26 receives, as inputs, the updated time-series data td1, td2, and td3 which are the outputs of the data update function F24, and the parameters of the approximate curve of the time-series data td1, td2, and td3 which are the outputs of the function F25 for generating an approximate curve. The data management function F26 stores the input information in the storage device 102 by the central processing unit 101. Further, the data management function F26 outputs the time-series data td1, td2, and td3 to the distance calculation function F22, the association function F23, the data update function F24, and the function F25 for generating an approximate curve by the central processing unit 101. Table 1 and Table 2 below show examples of the time-series data td1, td2, and td3 stored in the storage device 102. For the convenience of space, Table 1 and Table 2 are listed separately, but these are one continuous table with the identifier item as the first column.

TABLE 1

| | | | Number of | Coordinates | Parameters of | Parameters of |
|---|---|---|---|---|---|---|
| | | Point | points in | of the | the approximate | the error |
| | Time | sequence | the point | center of | curve (linear | ellipse (linear |
| Identifier | stamp | list | sequence | gravity | approximation) | approximation) |
| 1 | 10 | [0, 2.4] | 8 | [5, 2.2] | [a, b, c] | [5.2, 0.7] |
| | | [2, 2.2] | | | | |
| | | [4, 2.3] | | | | |
| | | . . . | | | | |
| 2 | 20 | [0, −1.9] | 6 | [2, −2.3] | [a′, b′, c′] | [4.8, 0.5] |
| | | [1, −2.0] | | | | |
| | | [2, −2.3] | | | | |
| | | . . . | | | | |
| . . . | . . . | . . . | . . . | . . . | . . . | . . . |

TABLE 2

| | | Error ellipse | |
|---|---|---|---|
| | Approximate curve | parameters | |
| | (circular | (circular | Approximate curve |
| Identifier | approximation) | approximation) | determination flag |
| 1 | [(15.6, 2.3), 13.4] | [0, 2.4] | Circular |
| | | | approximation |
| 2 | [(−7.3, 0.0), 5.3] | [0, −1.9] | Linear |
| | | | approximation |
| . . . | . . . | . . . | . . . |

The history management table, which is an example of time-series data td1, td2, and td3, includes, for example, an identifier, a time stamp, a point sequence list, the number of points of a point sequence, and a coordinate of the center of gravity of the point sequence in the part illustrated in Table 1. Further, in the part illustrated in Table 1, the history management table includes the approximate curve parameter representing the coefficient of the approximate straight line when the point sequence is expressed by linear approximation, and the error ellipse parameter representing the major axis and the minor axis obtained from the point sequence used when calculating the approximate straight line and the approximate straight line.

In addition, the history management table includes, for example, in the part illustrated in Table 2, the approximate curve parameter representing the center coordinates and radius of the approximate circle when the point sequence is represented by circular approximation, and the error ellipse parameter representing the point sequence used when calculating the approximate curve and the major axis and the minor axis of the error ellipse obtained from the approximate curve. Further, in the part illustrated in Table 2, the history management table includes, for example, an approximate curve determination flag indicating whether the approximate curve to be applied to each of the time-series data td1, td2, and td3 is the linear approximation or the circular approximation.

The data management function F26 uses, for example, the history management table stored in the storage device 102 to manage the point sequence information of the time-series data td1, td2, and td3 of the lane marker Lm at every entry of an identifier, a time stamp, and an approximate curve determination flag. The data management function F26 receives the outputs of the data update function F24 and the function F25 for generating an approximate curve as inputs, and edits the entry of the history management table based on the identifier on the basis of the input or adds a new entry to the history management table by the central processing unit 101.

For example, the sensor information processing device 100 executes end determination processing P29 of the processing P2 by the function F2 for assigning an identifier after the end of the processing P28 for generating an approximate curve illustrated in FIG. 5. In the end determination processing P29, when the central processing unit 101 determines that the processing P2 has not ended (NO), the function F2 for assigning an identifier returns to the processing P21 for acquiring the identification result Id as point sequence information from the function F1 for acquiring the point sequence information by the coordinate conversion function F21. On the other hand, in the end determination processing P29, when it is determined that the function F2 for assigning an identifier ends the processing P2 by the central processing unit 101 (YES), the processing P2 by the function F2 for assigning an identifier ends.

As illustrated in FIG. 2, the function F3 for outputting the lane marker information receives, as inputs, the identifier Idn of the lane marker Lm that is the output of the function F2 for assigning an identifier and the identification result Id of the lane marker Lm that is the output of the function F1 for acquiring the point sequence information. The function F3 for outputting the lane marker information outputs the recognition result R of the lane marker Lm to which the identifier is given on the basis of these inputs. For example, the function F3 for outputting the lane marker information assigns an identifier to the detection result De of the lane marker Lm by each external-environment sensor 200 by the central processing unit 101. In addition, the function F3 for outputting the lane marker information may integrate the point sequence of the identification result Ids of the lane markers Lm having the same identifier, and make the identification result Id of one lane marker Lm to correspond to one identifier in order to facilitate handling in the lane marker information integration device 500.

Hereinafter, the operation of the sensor information processing device 100 of the present embodiment will be described on the basis of the comparison with the conventional technique.

As the environment surrounding mobility, the number of cars is increasing and the aging of drivers is progressing. As social needs for this, eradication of traffic accidents, elimination of traffic congestion, and reduction of carbon dioxide emissions are required. In order to meet that demand, technological development for the realization of autonomous driving is accelerating. For example, at SAE (Society of Automotive Engineers) in the United States at level 3 or higher, the main body responsible for autonomous driving shifts to the system side. Therefore, for example, in order to prevent the automatic driving vehicle from deviating from the lane, it is necessary to recognize the lane markers that divide the lane by the external-environment sensor and identify each lane marker with high accuracy on the basis of the detection result.

In the conventional automatic traveling vehicle described in PTL 1 above, the rightmost lane boundary line is set as the reference lane boundary line, the distance from the own vehicle, which is the origin, to each lane boundary line is measured, the distance from the reference lane boundary line to each lane boundary line is obtained, and a lane boundary line number is assigned to each lane boundary line. Further, this conventional automatic traveling vehicle obtains a relative position in the road of the own vehicle, and obtains a value obtained by correcting the relative position in the road calculated at the previous time according to the movement locus of the own vehicle.

However, this conventional automatic traveling vehicle determines the continuity of the lane boundary line on the basis of the distance from the own vehicle to the nearest lane boundary line. Therefore, if the number of lanes increases or decreases due to, for example, the existence of a lane branching from a traveling lane or a lane joining the traveling lane, different lane boundaries may be mistakenly recognized as the same lane boundary.

On the other hand, the sensor information processing device 100 of the present embodiment is a device that identifies the lane marker Lm by processing the detection result De of a plurality of external-environment sensors 200 that recognize the lane marker Lm that divides the lane L. The sensor information processing device 100 includes the storage device 102 that stores the past detection result De of the external-environment sensor 200 as the time-series data td1, td2, and td3, and the central processing unit 101 that identifies the lane marker Lm on the basis of the time-series data td1, td2, and td3. The central processing unit 101 determines whether the new detection result De belongs to the existing lane marker Lm or the new lane marker Lm on the basis of the comparison between the new detection result De not included in the time-series data td1, td2, and td3 and the time-series data td1, td2, and td3.

With this configuration, the relevance between the inputs i1, i2, and i3 based on the new detection result De of the plurality of external-environment sensors 200 mounted on the vehicle V and the time-series data td1, td2, and td3 based on the detection result De acquired in the past. It is possible to assign identifiers to the inputs i1, i2, and i3. That is, whether the new inputs i1, i2, and i3 based on the detection result De of the external-environment sensor 200 belong to the existing or new lane marker Lm can be determined on the basis of the comparison between the inputs i1, i2, and i3 and the time-series data td1, td2, and td3. In this way, by comparing with the time-series data td1, td2, and td3 for which the lane marker Lm has already been identified, the identity between the new inputs i1, i2, and i3 of the lane marker Lm and the existing lane marker Lm can be determined more accurately. As a result, the identity of the lane marker Lm can be determined more accurately with respect to the increase in the lane markers Lm in front of and behind the vehicle V and the detection result De of the plurality of different external-environment sensors 200.

Therefore, for example, even if the number of lanes L increases or decreases due to the existence of a lane that branches off from the lane L in which the vehicle V is traveling or a lane that joins the lane in which the vehicle V is traveling, it is prevented that different lane markers Lm are recognized as the same lane marker Lm. As a result, it is possible to facilitate the integration of the lane marker Lm when the plurality of external-environment sensors 200 are used, and it is possible to improve the identification accuracy and the detection rate of the lane marker Lm. Therefore, according to the present embodiment, it is possible to provide the sensor information processing device 100 that processes the detection results De of the plurality of external-environment sensors 200 that recognize the lane marker Lm that divides the lane L and can identify the lane marker Lm more accurately than before.

Further, in the sensor information processing device 100 of the present embodiment, the central processing unit 101 stores the inputs i1, i2, and i3 as the time-series data td1, td2, and td3 in the storage device 102 after the inputs i1, i2, and i3 based on the new detection result De of the external-environment sensor 200 is determined to belong to the existing lane marker Lm or to the new lane marker Lm. With this configuration, the time-series data td1, td2, and td3 can be updated on the basis of the detection result De of the latest external-environment sensor 200.

Further, in the sensor information processing device 100 of the present embodiment, the central processing unit 101 assigns the identifier, which is unique to each identified lane marker Lm, to the time-series data td1, td2, and td3 and the inputs i1, i2, and i3 based on the new detection result. With this configuration, each of the inputs i1, i2, and i3 can be associated with each of the time-series data td1, td2, and td3.

Further, in the sensor information processing device 100 of the present embodiment, the detection result De of the external-environment sensor 200 includes the point sequence information. With this configuration, it is possible to execute various processing and operations as described above while suppressing the capacity.

Further, in the sensor information processing device 100 of the present embodiment, the detection result De of the external-environment sensor 200 includes the parameter of the approximate curve. More specifically, for example, the time-series data td1, td2, and td3 based on the past detection result De of the external-environment sensor 200 includes the parameters of the approximate curve. With this configuration, it is possible to reduce the amount of calculation in the identification of the lane marker Lm based on the time-series data td1, td2, and td3 and in the determination based on the comparison between the inputs i1, i2, and i3 and the time-series data td1, td2, and td3.

As described above, according to the present embodiment, it is possible to provide the sensor information processing device 100 that processes the detection results De of the plurality of external-environment sensors 200 that recognize the lane marker Lm that divides the lane L and can identify the lane marker Lm more accurately than before.

### Second Embodiment

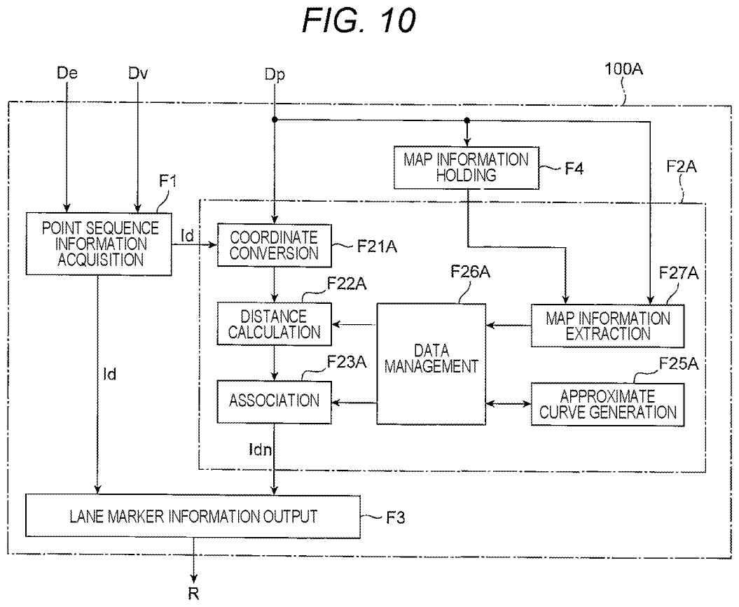

Next, referring to FIGS. 1, 3A to 3C, and 5 to 9, the second embodiment of the sensor information processing device according to the present disclosure will be described with reference to FIG. 10. FIG. 10 is a functional block diagram of a sensor information processing device 100A of the present embodiment. Note that FIG. 10 corresponds to FIGS. 2 and 4 in the sensor information processing device 100 of the first embodiment.

The sensor information processing device 100A of the present embodiment is different from the sensor information processing device 100 of the above-described first embodiment in the configurations of the central processing unit 101 and the storage device 102. Since the other configurations of the sensor information processing device 100A of the present embodiment are the same as those of the sensor information processing device 100 according to the first embodiment, the same reference numerals are given to the same configurations and the description thereof will be omitted.

The sensor information processing device 100A of the present embodiment is different from the sensor information processing device 100 of the first embodiment mainly in that a map information holding function F4 is provided, and in that the function F2A for assigning an identifier has a map information extraction function F27A and has no data update function F24. Further, a distance calculation function F22A, an association function F23A, a function F25A for generating an approximate curve, and a data management function F26A provided in the function F2A for assigning an identifier are different from the distance calculation function F22, the association function F23, the function F25 for generating an approximate curve, and the data management function F26 of the first embodiment.

The above-mentioned functions in the sensor information processing device 100A of the present embodiment are the same as those of the sensor information processing device 100 of the first embodiment. For example, each function is configured by the CPU 101 constituting the sensor information processing device 100A, the storage device 102, a computer program stored in the storage device 102, and an input/output device (not illustrated). In the sensor information processing device 100A of the present embodiment, the storage device 102 stores map information including the information of the lane marker Lm.

The map information holding function F4 receives, for example, the detection result Dp, which is the output of the positioning sensor 400, as inputs. In the map information holding function F4, the central processing unit 101 outputs the map information stored in the storage device 102 to the map information extraction function F27A on the basis of the position information which is the detection result Dp of the positioning sensor 400.

Here, the map information stored in the storage device 102 is, for example, a high-precision map created offline based on the data measured with high accuracy by LIDAR. The map information may be, for example, a dynamically generated map constructed by collecting the recognition results of a plurality of probes equipped with LIDAR or a stereo camera in cloud storage. Further, as the map information, a map for car navigation may be used.

Further, in the map information holding function F4, the central processing unit 101 acquires, for example, a map around the vehicle V from the cloud storage on the basis of the position of the vehicle V included in the detection result Dp by the positioning sensor 400, and stores the map in the storage device 102 as map information. The map information includes, for example, the number of lanes L on the road Rd, the speed limit, the radius of curvature, the longitudinal gradient, the cross gradient, the width of the lane L, the information on the lane marker Lm, the lane center point, and the like.

The coordinate conversion function F21A has the same function as the coordinate conversion function F21 of the first embodiment. The distance calculation function F22A has the same function as the distance calculation function F22 of the first embodiment, but the input from the data management function F26A becomes the information of the lane marker Lm included in the map information.

The association function F23A has the same function as the association function F23 of the first embodiment, but the input from the data management function F26A becomes the information of the lane marker Lm included in the map information. Further, in the association function F23A, the output of the distance calculation function F22A is associated with the information of the lane marker Lm included in the map information which is the output of the data management function F26A, but the output of the distance calculation function F22A is not necessarily stored in the storage device 102. Therefore, the association function F23A outputs the identification result Idn of the lane marker Lm to which the identifier is given only to the function F3 for outputting the lane marker information.

The function F25A for generating an approximate curve has the same function as the function F25 for generating an approximate curve of the first embodiment, but the input from the data management function F26A becomes the information of the lane marker Lm included in the map information. Further, the function F25A for generating an approximate curve generates an approximate curve on the basis of the information of the lane marker Lm included in the map information input from the data management function F26A and outputs the approximate curve to the data management function F26A.

The map information extraction function F27A extracts the information of the lane marker Lm of each lane L on the basis of the detection result Dp output from the positioning sensor 400 and the map information output from the map information holding function F4, and outputs the information to the data management function F26A. The map information extraction function F27A extracts the information of the lane marker Lm in the required range on the basis of the position of the vehicle V included in the detection result Dp of the positioning sensor 400.

The map information extraction function F27A may extract the information of the lane marker Lm in the range that can be detected by the external-environment sensor 200 to reduce the information capacity. The information of the lane marker Lm includes, for example, information regarding an identifier and a position associated with each lane L. Since the identifier of the lane marker Lm based on the map information is determined in advance by measuring, it can be used as the basis of the identifier set by the association function F23A.

In the present embodiment, the information of the lane marker Lm, which is the output of the map information extraction function F27A, is in the point sequence format in the same fixed coordinate system as the coordinate conversion function F21A. However, if the map information includes the information of the lane marker Lm as the coefficient of the approximate curve parameter, it can be converted into a point sequence on the basis of the coefficient of the approximate curve parameter as in the function F1 for acquiring the point sequence information.

Further, when the approximate curve parameter input from the map information holding function F4 is the same approximation as the linear approximation or the circular approximation of the approximate curve generated by the function F25A for generating an approximate curve, the map information extraction function F27A is not necessary to convert to the point sequence format. In this case, the map information extraction function F27A may output the coefficients of the approximate curve parameters to the data management function F26A instead of the function F25A for generating an approximate curve. As a result, the processing of the function F25A for generating an approximate curve can be omitted, and the processing load can be reduced.

The data management function F26A has the same function as the data management function F26 of the first embodiment, but outputs the information of the lane marker Lm input from the map information extraction function F27A to the distance calculation function F22A, the association function F23A, and the function F25A for generating an approximate curve.

As described above, in the sensor information processing device 100A of the present embodiment, the storage device 102 stores map information including the information of the lane marker Lm. Further, in the sensor information processing device 100A of the present embodiment, the central processing unit 101 associates the lane marker Lm included in the map information stored in the storage device 102 with the lane marker Lm based on the time-series data td1, td2, and td3 on the basis of the position information that is the detection result Dp input from the positioning sensor 400.

According to the sensor information processing device 100A of the present embodiment, the lane marker Lm can be identified on the basis of the map information. The map information is data measured offline with high accuracy or the latest data collected and shaped by a plurality of probes. Therefore, the lane marker Lm can be highly accurately associated with the information of the lane marker Lm based on the detection result De by the external-environment sensor 200 mounted on the vehicle V, and even the lane marker Lm on the road Rd having a complicated shape can be accurately identified. Therefore, according to the sensor information processing device 100A of the present embodiment, it is possible to realize highly accurate lane tracking and lane change in AD and ADAS of the vehicle V.

As described above, the embodiment of the sensor information processing device according to the disclosure has been described in detail with reference to the drawings. However, the specific configuration is not limited to this embodiment, and there are design changes and the like without departing from the gist of the disclosure, which are also included in the disclosure.

### REFERENCE SIGNS LIST

L lane
Lm lane marker
100 sensor information processing device
101 central processing unit
102 storage device
200 external-environment sensor
i1 input (new detection result)
i2 input (new detection result)
i3 input (new detection result)
td1 time-series data
td2 time-series data
td3 time-series data

1. A sensor information processing device that identifies a lane marker by processing detection results of a plurality of external-environment sensors that recognize the lane marker that divides a lane, the sensor information processing device comprising:
a storage device that stores past detection results as time-series data; and
a central processing unit that identifies the lane marker on a basis of the time-series data, wherein
on a basis of a comparison between the new detection result not included in the time-series data and the time-series data, the central processing unit determines that the new detection result belongs to the existing lane marker or the new lane marker.

2. The sensor information processing device according to claim 1, wherein the central processing unit causes the storage device to store the new detection result after the determination as the time-series data.

3. The sensor information processing device according to claim 1, wherein the central processing unit assigns an identifier unique to each of the identified lane markers to the time-series data and the new detection result.

4. The sensor information processing device according to claim 1, wherein
the storage device stores map information including information of the lane marker, and
the central processing unit associates the lane marker included in the map information with the lane marker based on the time-series data on a basis of position information input from a positioning sensor.

5. The sensor information processing device according to claim 1, wherein the detection result of the external-environment sensor includes point sequence information.

6. The sensor information processing device according to claim 1, wherein the detection result of the external-environment sensor includes a parameter of an approximate curve.
